(19) United States
(12) Patent Application Publication
(10) Pub. No.: US 2012/0217431 A1
(43) Pub. Date: Aug. 30, 2012

(54) MAGNETIC MATERIAL FOR HIGH FREQUENCY APPLICATIONS AND HIGH FREQUENCY DEVICE

(75) Inventor: Akira Nakamura, Ebina-shi (JP)

(73) Assignee: Mitsumi Electric Co. Ltd., Tokyo (JP)

(21) Appl. No.: 13/502,200

(22) PCT Filed: Oct. 13, 2010
(86) PCT No.: PCT/JP2010/067907

§ 371 Date: Apr. 16, 2012

(30) Foreign Application Priority Data
Oct. 16, 2009 (JP) 2009-238902
Oct. 19, 2009 (JP) 2009-240074

(51) Int. Cl. H01F 1/42

(52) U.S. Cl. 252/62.54

(57) ABSTRACT

A high-frequency magnetic material includes magnetic particles dispersed in a resin material. The magnetic particles have an approximately spherical shape, and the resin material contains 1 to 60 vol % of the magnetic particles. The magnetic particles have a saturated flux density of 1 T or more. A magnetic anisotropy constant of the magnetic particles is K1<±800·10³ (J/m³) for a cubic crystal material or Ku<±400·10³ (J/m) for a uniaxial anisotropic material.

### TECHNICAL FIELD

The present invention relates to a high-frequency magnetic material and a high-frequency device.

### BACKGROUND ART

Until now, magnetic materials have been used in various applied magnetic products. Among these magnetic materials, soft magnetic materials have a large change in magnetization in a weak magnetic field.

Soft magnetic materials are classified into metallic materials, amorphous materials, and oxide materials, depending on the type of material. Among soft magnetic materials, oxide materials (ferrite materials), which exhibit high resistivity and reduced eddy current loss, are used at MHz or higher frequencies. For example, Ni—Zn ferrite materials are known as ferrite materials for use in high frequencies.

Soft magnetic materials including the ferrite materials exhibit a reduction in the real part Re (μ) and an increase in the imaginary part Im (μ) of the complex magnetic permeability accompanied by magnetic resonance at a high frequency of about 1 GHz. Because the imaginary part Im (μ) of the complex magnetic permeability produces an energy loss P represented by P=½·ωμ₀ Im (μ) H² where ω represents angular frequency, μ₀ represents magnetic permeability in vacuum, and H represents intensity of the magnetic field, a high value of the imaginary part Im (μ) of the complex magnetic permeability is not preferred for use in a magnetic core or an antenna from a practical standpoint.

In contrast, the real part Re (μ) of the complex magnetic permeability represents the electromagnetic-wave converging effect or wavelength reduction effect; hence, a high value is preferred from a practical standpoint.

An index representing the energy loss (magnetic loss) of a magnetic material used sometimes is tangent delta (tan δ=Im (μ)/Re (μ). At a high tangent delta, magnetic energy is converted to thermal energy in a magnetic material to reduce a transmission efficiency of required energy. A low tangent delta is therefore preferred. Hereinafter, the magnetic loss is referred to as a tangent delta (tan δ).

Thin-film materials having a low tan δ in a high frequency band (GHz band) are present among the soft magnetic materials. Examples of the thin-film material include Fe-based soft magnetic films with high electrical resistivity and Co-based films with high electrical resistivity. Since the volume of the thin-film material is small, its range of applications is limited. Another problem is a complicated process for manufacturing a thin film that requires expensive facilities.

As a solution to such problems, resin molding of a composite magnetic material where a magnetic material is dispersed in a resin is employed. For example, an electromagnetic-wave absorber is known which is produced by compounding powdered nano-crystal soft magnetic material with a resin and which has excellent broadband electromagnetic-wave absorption characteristics (for example, refer to Patent Document 1).

### PRIOR ART DOCUMENTS

### Patent Documents

Patent Document 1: Japanese Patent Publication Laid-Open No. 11-354973

### DISCLOSURE OF INVENTION

### Problems to be Solved by the Invention

Important parameters on magnetic particles for a reduction in tan δ (loss reduction) are the shape of the magnetic particle, the content of the magnetic particles in a resin, the saturated magnetization of the magnetic particles, and the magnetic anisotropy constant of the magnetic particles, in the case of molding of a magnetic material (high-frequency magnetic material) usable in various high-frequency applied magnetic products.

In the case where the applied product is a magnetic antenna produced by molding of the high-frequency magnetic material, use of a high-frequency magnetic material having a low tan δ can enhance radiation efficiency. It has been therefore required to reduce the loss of high-frequency magnetic materials.

An object of the present invention is to optimize conditions on magnetic particles or to achieve low loss of high-frequency magnetic materials by magnetizing a composite magnetic material that contains magnetic particles isolated in a resin.

### Means for Solving Problems

To achieve the above object, the present invention provides a high-frequency magnetic material including magnetic particles dispersed in a resin material, wherein the magnetic particles have an approximately spherical shape; the resin material contains 1 to 60 vol % of the magnetic particles; the magnetic particles have a saturated flux density of 1 T or more; and a magnetic anisotropy constant of the magnetic particles is K1<±800·10³ (J/m³) for a cubic crystal material or Ku<±400·10³ (J/m³) for a uniaxial anisotropic material.

Further, the present invention provides a high-frequency magnetic material including magnetic particles dispersed in a resin material, wherein the magnetic particles have an approximately spherical shape with an average diameter d of 0.1<d<1 (μm) and a relative particle volume f(d) at each diameter satisfying a relationship:

Σ{f(d)·d²}<6.7·10⁻¹²

Preferably, the magnetic particles have a flattening ratio in the range of 0.36 to 2.50.

Further, the present invention provides a high-frequency magnetic material including magnetic particles dispersed in a resin material, wherein the magnetic particles have an approximately spherical shape and the magnetic material is magnetized.

Preferably, the magnetic particles have an eddy magnetization distribution therewithin.

Preferably, the magnetic material is magnetized while the magnetic particles are being dispersed in the resin material or after the magnetic particles are dispersed in the resin material.

Preferably, the magnetic material is magnetized in a direction parallel to a principal magnetic-field-action direction of an applied device.

Preferably, the high-frequency magnetic material is applied to a high-frequency device including at least one of an antenna, a circuit substrate, and an inductor.

### Effects of the Invention

The present invention provides the optimized conditions on magnetic particles or low loss of high-frequency magnetic material through magnetization of a composite magnetic material that contains magnetic particles isolated in a resin.

### BRIEF DESCRIPTION OF DRAWINGS

FIG. 1 illustrates calculated results of the magnetic permeability Re (μ) versus diameter of magnetic particles.

FIG. 2 illustrates calculated results of the magnetic permeability Re (μ) and tan δ versus diameter of magnetic particles.

FIG. 3A illustrates the diameter (d) and thickness (t) of magnetic particles.

FIG. 3B illustrates the calculated results of magnetic permeability Re (μ) and tan δ versus flattening ratio of magnetic particles.

FIG. 4 illustrates calculated results of magnetic permeability Re (μ) and tan δ versus saturated flux density of magnetic particles.

FIG. 5 illustrates calculated results of magnetic permeability Re (μ) and tan δ versus magnetic anisotropy constant K1 for magnetic particles having a cubic crystal structure.

FIG. 6 illustrates calculated results of magnetic permeability Re (μ) and tan δ versus magnetic anisotropy constant Ku for magnetic particles of a uniaxial anisotropic material.

FIG. 7 illustrates calculated results of magnetic permeability Re (μ_{comp.}) and tan δ_{comp.} of a high-frequency magnetic material at variable filling rates of magnetic particles relative to a resin.

FIG. 8 illustrates calculated results of the magnetic permeability Re (μ_{comp.}) and tan δ_{comp.} of a conventional high-frequency magnetic material and a high-frequency magnetic material of the present invention.

FIG. 9A illustrates an exemplary antenna composed of a high-frequency magnetic material.

FIG. 9B illustrates an exemplary antenna composed of a high-frequency magnetic material.

FIG. 9C illustrates an exemplary antenna composed of a high-frequency magnetic material.

FIG. 9D illustrates an exemplary antenna composed of a high-frequency magnetic material.

FIG. 10 illustrates an exemplary antenna composed of a high-frequency magnetic material.

FIG. 11 illustrates an exemplary inductor composed of a high-frequency magnetic material.

FIG. 12 illustrates an exemplary circuit substrate composed of a high-frequency magnetic material.

FIG. 13 illustrates magnetization distribution in a magnetic particle.

FIG. 14A illustrates magnetic permeability Re (μ) under a magnetic field applied in the X direction or the Z direction.

FIG. 14B illustrates tan δ under a magnetic field applied in the X direction or the Z direction.

FIG. 15A is a top view of a measurement system.

FIG. 15B is a side view of a measurement system.

FIG. 16A illustrates evaluated results of magnetic permeability Re (μ) and tan δ after parallel magnetization.

FIG. 16B illustrates evaluated results of magnetic permeability Re (μ) and tan δ after vertical magnetization.

FIG. 17 illustrates a toroidal coil that is circumferentially magnetized.

FIG. 18 illustrates integration of a plurality of individually magnetized members.

### BEST MODE FOR CARRYING OUT THE INVENTION

Hereinafter, a first embodiment and a second embodiment of the present invention are described in detail with reference to attached drawings. The scope of the invention, however, should not be limited to the embodiments shown in the drawings.

### First Embodiment

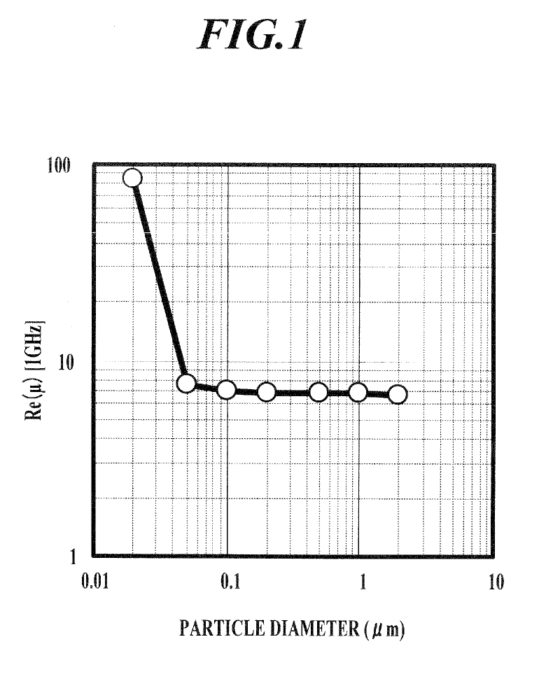

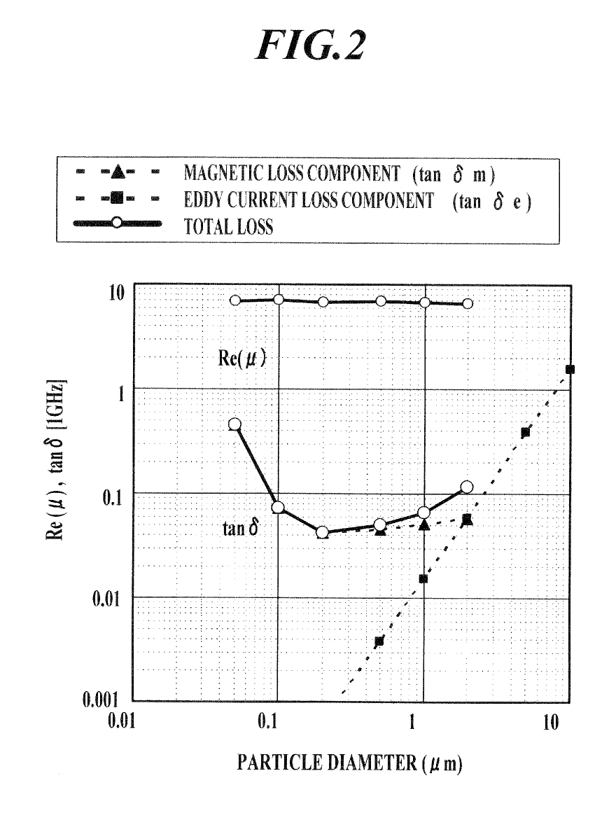

The first embodiment of the present invention will now be described. First, the calculated results of the real part Re (μ) of the complex magnetic permeability and tan δ are described with reference to FIGS. 1 and 2.

In the calculation of the real part Re (μ) of the complex magnetic permeability and tan δ shown in FIGS. 1 and 2, characteristics of a single isolated magnetic particle were calculated based on the assumption that the magnetic material of Fe (iron) has a spherical shape at a frequency of 1 GHz. Complex relative magnetic permeability at a high frequency (high-frequency complex relative magnetic permeability) is defined by μ=Re (μ)−j·Im (μ) (where j is imaginary unit), and tan δ=Im (μ)/Re (μ). The commonly used relative magnetic permeability corresponds to the real part Re (μ) of the complex relative magnetic permeability. Hereinafter, the relative magnetic permeability is simply referred to as a magnetic permeability Re (μ) in this embodiment.

FIG. 1 illustrates the calculated results of magnetic permeability Re (μ) versus particle diameter of magnetic particles. The lateral axis represents the particle diameter of the magnetic particles. The longitudinal axis represents magnetic permeability Re (μ). The magnetic permeability Re (μ) was calculated by micro-magnetic simulation. In the micro-magnetic simulation, magnetization response to a high-frequency magnetic field is Fourier-transformed to obtain complex magnetic susceptibility χ=Re (χ)−j·Im (χ) and magnetic permeability Re (μ)=1+Re (χ).

As a result of calculation under such conditions, the magnetic permeability Re (μ) was approximately constant at 7 for a particle diameter from 0.1 to 1 μm of the magnetic particle as illustrated in FIG. 1.

FIG. 2 illustrates the calculated result of tan δ versus particle diameter of magnetic particles. The lateral axis represents the particle diameter of the magnetic particles. The longitudinal axis represents tan δ. The magnetic loss component (tan δm) and the eddy current loss component (tan δe) were separately calculated. The magnetic loss component (tan δm) was calculated by micro-magnetic simulation. The eddy current loss component (tan δe) was calculated from the equation tan δe=πd²μ₀ Re (μ) f/cρ (where d: particle diameter, μ₀: magnetic permeability in vacuum, Re (μ): magnetic permeability, f: frequency (at 1 GHz), c: shape factor (20 for sphere), and ρ: resistivity). The tan δ was calculated by adding up the magnetic loss component and the eddy current loss component.

The calculation under the above conditions resulted in a tan δ equal to or less than 0.1 for a particle diameter from 0.1 to 1 μm as illustrated in FIG. 2. A lower tan δ, for example, not higher than 0.05 was obtained for a particle diameter from 0.2 to 0.5 μm.

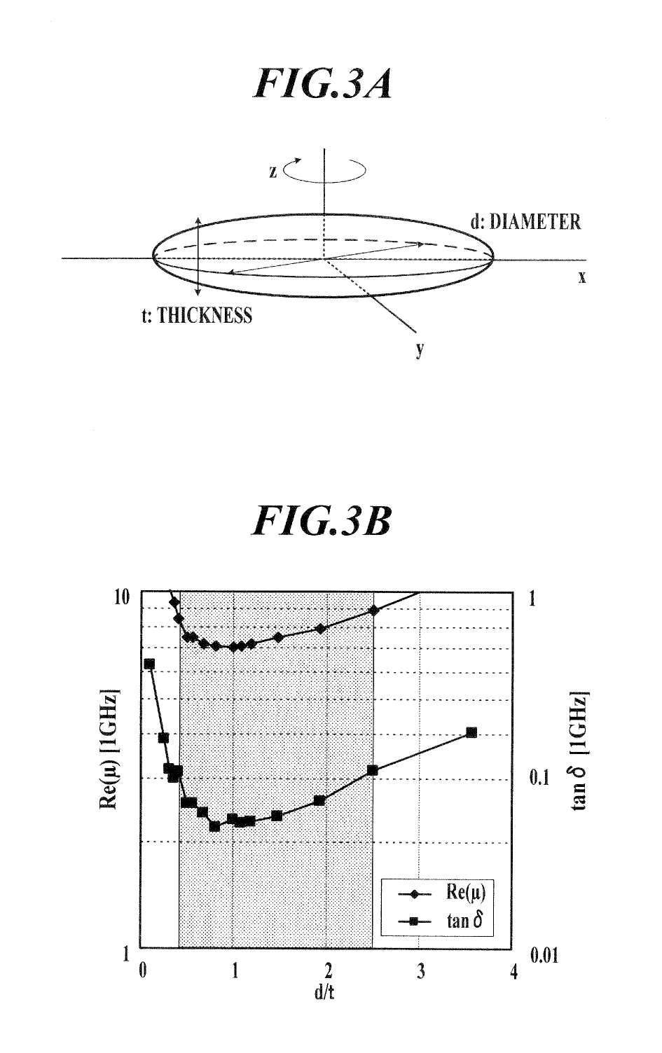

With reference to FIGS. 3A and 3B, magnetic permeability Re (μ) and tan δ characteristics versus flattening ratio of magnetic particles (calculated results) are then described. The flattening ratio corresponds to diameter (d)/thickness (t) of the magnetic particle shown in FIG. 3A. The lateral axis of FIG. 3B represents the flattening ratio (d/t). The longitudinal axis represents the magnetic permeability Re (μ) and the tan δ at 1 GHz. As illustrated in FIG. 3B, a low tan δ not higher than 0.1 was obtained for a flattening ratio in the range of 0.36 to 2.50.

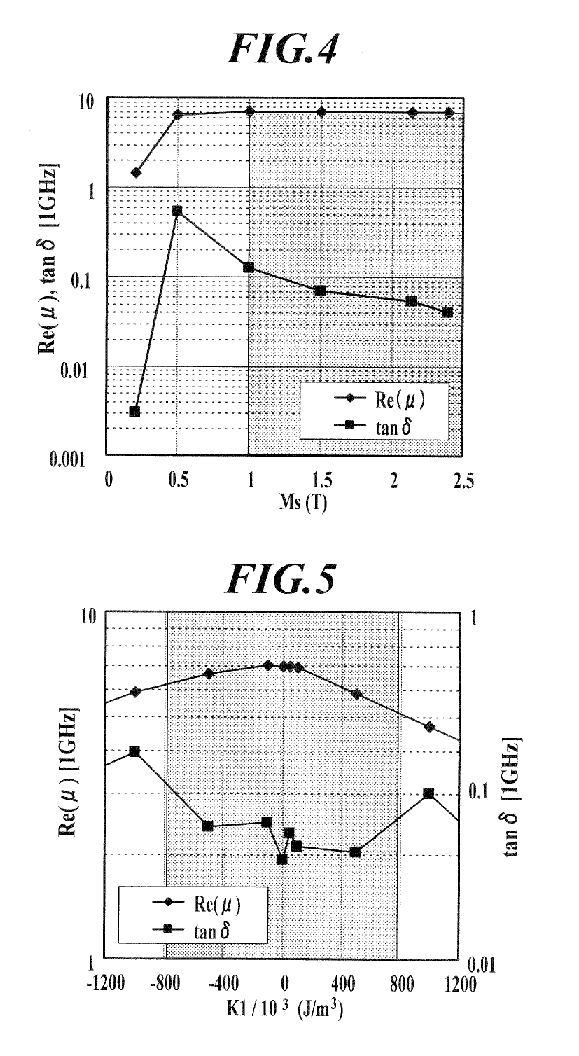

With reference to FIG. 4, magnetic permeability Re (μ) and tan δ characteristics versus saturated flux density of magnetic particles will now be described. The lateral axis of FIG. 4 represents the saturated flux density Ms (T) of magnetic particles. The longitudinal axis represents the magnetic permeability Re (μ) and tan δ at 1 GHz. As illustrated in FIG. 4, a low tan δ not higher than 0.1 was observed at a saturated flux density of 1 T or more.

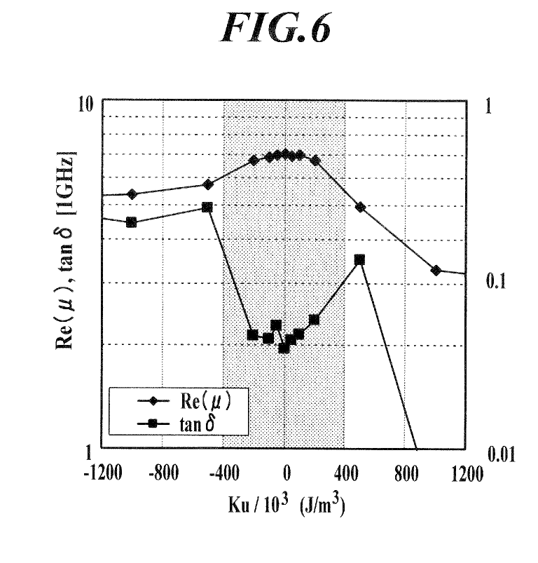

With reference to FIGS. 5 and 6, magnetic permeability Re (μ) and tan δ characteristics versus magnetic anisotropy constant will then be described. FIG. 5 illustrates the magnetic permeability Re (μ) and tan δ versus magnetic anisotropy constant K1 of magnetic particles having a cubic crystal structure. The lateral axis of FIG. 5 represents the magnetic anisotropy constant K1 of the material having the cubic crystal structure. The longitudinal axis represents the magnetic permeability Re (μ) and tan δ at 1 GHz. As illustrated in FIG. 5, a low tan δ not higher than about 0.1 was observed at a magnetic anisotropy constant in the range of K1<±800·10³ (J/m³).

FIG. 6 illustrates magnetic permeability Re (μ) and tan δ characteristics versus magnetic anisotropy constant Ku of magnetic particles of a uniaxial anisotropic material. The lateral axis of FIG. 6 represents the magnetic anisotropy constant Ku of a uniaxial anisotropic material. The longitudinal axis represents the magnetic permeability Re (μ) and tan δ at 1 GHz. As illustrated in FIG. 6, a low tan δ not higher than about 0.1 was observed at a magnetic anisotropy constant in the range of Ku<±400·10³ (J/m³).

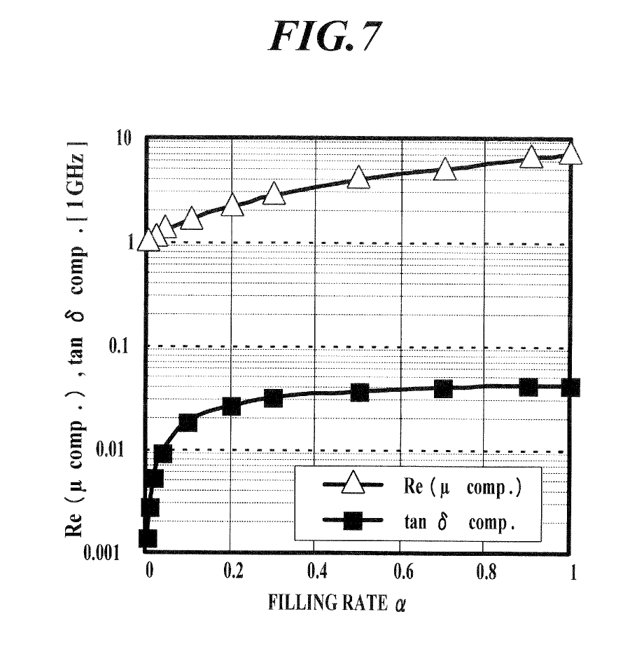

With reference to FIG. 7, the calculated magnetic permeability Re (μ_{comp.}) and tan δ_{comp.} of composite materials (high-frequency magnetic material) containing various amounts (filling rates) of magnetic particles relative to a resin will now be described. In this embodiment, the magnetic permeability of the high-frequency magnetic material is represented by Re (μ_{comp.}) and tangent delta by tan δ_{comp.} in order to be distinguished from the magnetic permeability Re (μ) and tan δ of net magnetic particles illustrated in FIGS. 1 to 6. The filling rate is defined as a volume ratio of magnetic particles to the total volume of the composite material.

Specifically, FIG. 7 illustrates calculated magnetic permeability Re (μ_{comp.}) and tan δ_{comp.} at various filling rates of Fe particles with a particle diameter of 0.2 μm. The lateral axis represents filling rate α. The longitudinal axis represents magnetic permeability Re (μ_{comp.}) and tan δ_{comp.} Characteristics of the composite material are represented by Re (μ_{comp.})=1+α·Re (χ) and tan δ_{comp.}=αIm (χ)/(1+αRe (χ)), using the filling rate α. The calculation of the expressions gives the relation between the magnetic permeability Re (μ_{comp.}) and tan δ_{comp.} illustrated in FIG. 7.

With reference to the relation between the magnetic permeability Re (μ_{comp.}) and the tan δ_{comp.} illustrated in FIG. 7, a filling rate suitable for a product design (design of an applied magnetic product) can be selected. Selection of an excessively high filling rate leads to poor kneadability and formability and increased magnetization loss due to magnetic interaction among magnetic particles. An excessively high filling rate is thus not preferred. A filling rate of 1 to 60 vol % is preferred.

Although the above calculated results are based on a single particle diameter, actual particles that can be prepared have a particle diameter distribution. As illustrated in FIG. 2, particles having a large diameter cause tan δ to increase due to eddy current loss. The tan δ due to the eddy current loss in consideration of the particle diameter distribution is represented by Σ{f(d)·tan δe}, where f(d) represents relative particle volume at each particle diameter and is a ratio of the total volume of particles, whose diameter is within the range including a particle diameter d as a representative value, to the total volume of all the particles. From the relationships expressed by tan δe=πd²μ₀ Re (μ) f/cρ and μ₀=4π·10⁻⁷, Re (μ)=6.7 (average magnetic permeability at a particle diameter range from 0.1 to 1 μm in FIG. 1), f=1 (GHz), c=20, and ρ=8.9·10⁻⁸ (Ω·m), a low tan δ lower than 0.1 is obtained in the case where the following relationship is satisfied:

Σ{f(d)·d²}<6.7·10⁻¹²

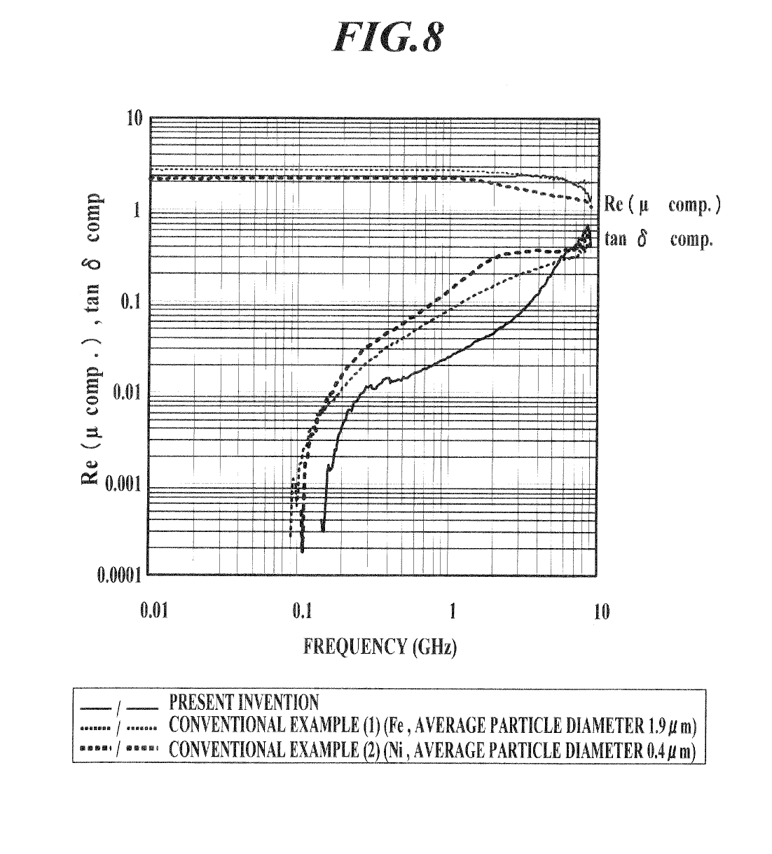

Then, characteristics of a shaped product (high-frequency magnetic material) made under conditions based on the calculated results illustrated in FIGS. 1 to 7 are described. FIG. 8 illustrates the magnetic permeability Re (μ_{comp.}) and tan δ_{comp.} of conventional high-frequency magnetic materials (corresponding to Conventional examples (1) and (2) in FIG. 8) and the magnetic permeability Re (μ_{comp.}) and tan δ_{comp.} of a high-frequency magnetic material (corresponding to the present invention in FIG. 8) made under conditions selected on the basis of the calculated results illustrated in FIGS. 1 to 7 (conditions: approximately spherical magnetic particles, a magnetic particle content of 1 to 60 vol %, a saturated flux density of 1 T or more, and a magnetic anisotropy constant of the magnetic particles of ±800·10³ (J/m³) for a cubic crystal material or ±400·10³ (J/m³) for a uniaxial anisotropic material).

A method of evaluating the shaped product (high-frequency magnetic material) of the present invention illustrated in FIG. 8 is as follows. The particles in the shaped product (high-frequency magnetic material) used in the following description have a particle diameter distribution. The average particle diameter is defined as a median diameter (D50) of the volume-based particle size distribution in this embodiment. The particle size distribution can be evaluated by a static light-scattering process.

Fe particles with an average diameter of 0.4 μm were dispersed in a thermosetting epoxy resin with a biaxial rotation kneader to produce paste fluid. The filling rate of the Fe particles to the thermosetting epoxy resin was 30 vol % on this occasion. The paste fluid was cured at 60° C. for 3.5 hours on a hot plate to produce a shaped product with a length of 10 mm, a width of 10 mm, and a thickness of 1 mm. The shaped product was machined into sizes of a length of 4 mm, a width of 4 mm, and a thickness of 0.7 mm to evaluate its magnetic permeability Re (μ_{comp.} ) and tan δ_{comp.} with a high-frequency magnetic permeability measurement device available in the market. FIG. 8 illustrates the evaluated results. The magnetic permeability Re (μ_{comp.}) and tan δ_{comp.} of a composite material (high-frequency magnetic material) containing Fe particles with an average diameter of 1.9 μm and a composite material (high-frequency magnetic material) containing Ni particles with an average diameter of 0.4 μm are illustrated as conventional examples in FIG. 8.

As illustrated in FIG. 8, the tan δ_{comp.} of the present invention is lower than the tan δ_{comp.} of the conventional examples in the entire frequency region.

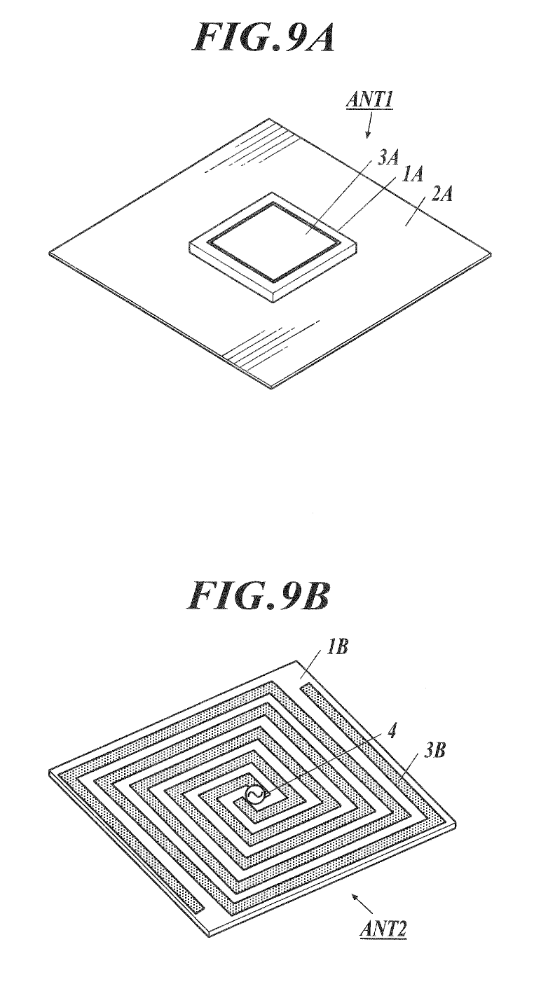

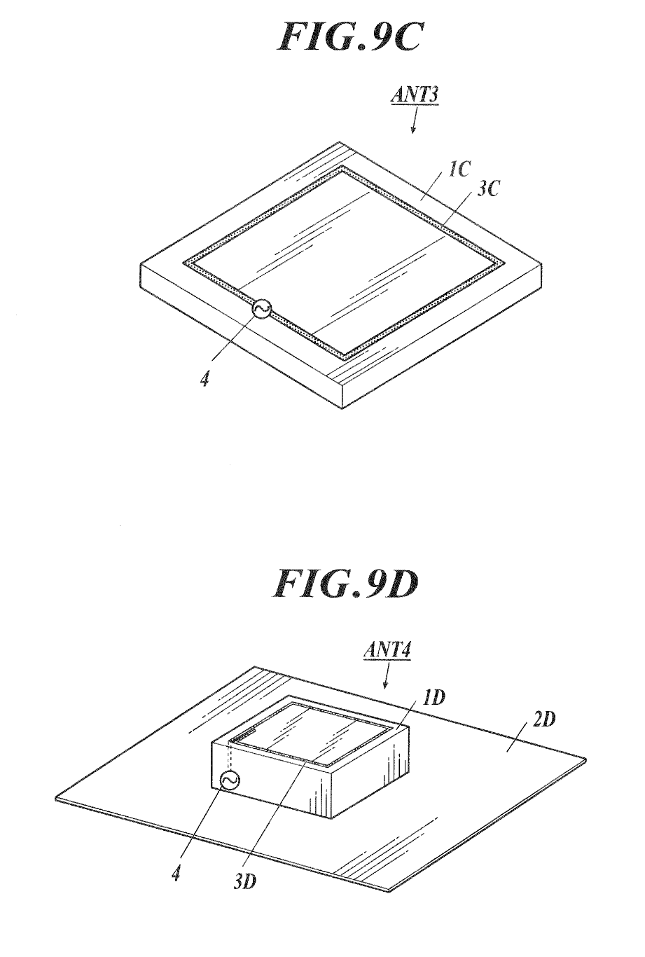

With reference to FIGS. 9A to 12, an exemplary application of the high-frequency magnetic material of the present invention to a high-frequency device (an antenna, an inductor, or a circuit substrate) is then described.

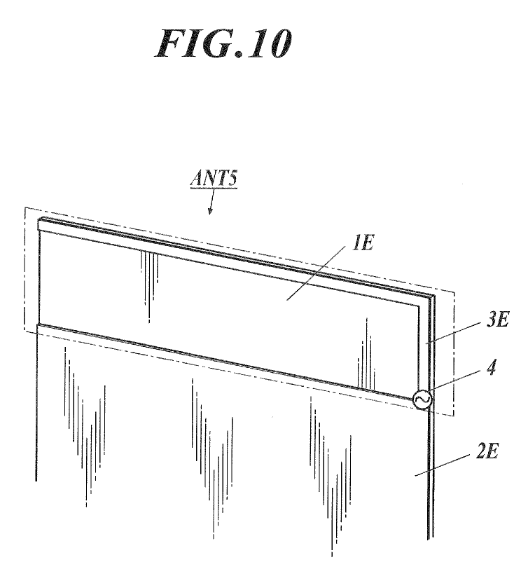

FIGS. 9A, 9B, 9C, 9D, and 10 each illustrate an exemplary antenna composed of a high-frequency magnetic material. An antenna ANT1 illustrated in FIG. 9A includes a high-frequency magnetic material 1A, a ground plate 2A, and an electrode 3A. The ANT1 includes the high-frequency magnetic material 1A on the ground plate 2A, and the electrode 3A on the high-frequency magnetic material 1A.

The antenna ANT2 illustrated in FIG. 9B includes a high-frequency magnetic material 1B, an electrode 3B, and an alternating current source 4. The alternating current source 4 represents a power feeding point (ditto with a current source illustrated in FIG. 9C, 9D, or 10). The ANT2 includes an electrode 3B on the high-frequency magnetic material 1B. Alternatively the electrode 3B may be embedded in the high-frequency magnetic material 1B.

The antenna ANTS illustrated in FIG. 9C includes a high-frequency magnetic material 1C, an electrode 3C, and an alternating current source 4. The electrode 3C may be arranged in the interior of the high-frequency magnetic material 1C in the antenna ANT3.

The antenna ANT4 illustrated in FIG. 9D includes a high-frequency magnetic material 1D, a ground plate 2D, an electrode 3D, and an alternating current source 4. The ANT4 includes the high-frequency magnetic material 1D on the ground plate 2D, and the electrode 3D embedded in the high-frequency magnetic material 1D. Alternatively the electrode 3D may be arranged in the interior of the high-frequency magnetic material 1C.

The antenna ANT5 illustrated in FIG. 10 includes a high-frequency magnetic material 1E, a ground plate 2E, and an electrode 3E. The ANT5 has a surface of the high-frequency magnetic material 1E flush with at least one surface of the ground plate 2E, and the electrode 3E is formed on the high-frequency magnetic material 1E.

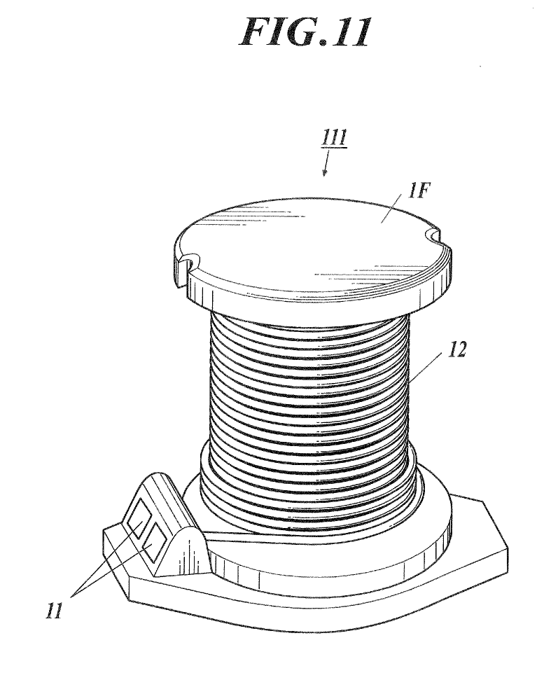

With reference to FIG. 11, an exemplary inductor 111 composed of a high-frequency magnetic material is then described. The inductor 111 illustrated in FIG. 11 includes a high-frequency magnetic material 1F, terminals 11, and a winding 12. The high-frequency magnetic material 1F constitutes the inductor 111 in this configuration.

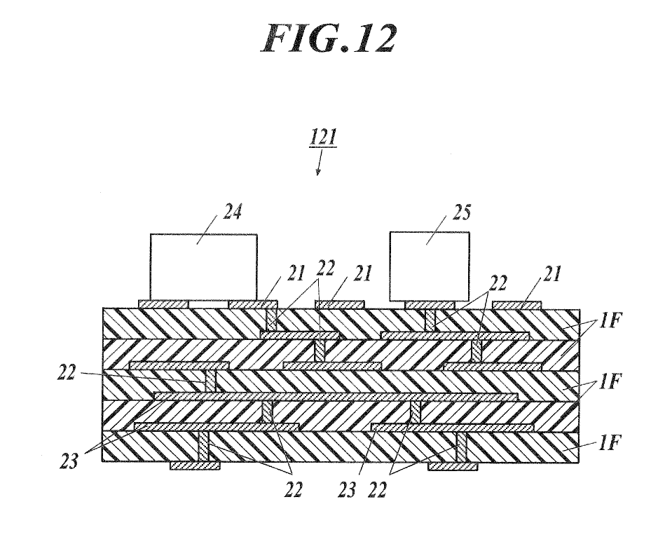

With reference to FIG. 12, an exemplary circuit substrate 121 composed of a high-frequency magnetic material is then described. The circuit substrate illustrated in FIG. 12 includes a high-frequency magnetic material 1F, lands 21, via holes 22, internal electrodes 23, and mounted components 24 and 25. The high-frequency magnetic material 1F is used in all the layers in FIG. 12. Alternatively, the high-frequency magnetic material 1F may be used in at least one layer of them. The high-frequency magnetic material 1F constitutes the circuit substrate 121 in this configuration.

This embodiment allows a tan δ to be not higher than 0.1 under conditions of approximately spherical magnetic particles, a content of 1 to 60 vol %, a saturated magnetization not less than 1 T, and a magnetic anisotropy constant of ±800·10³ (J/m³) for a cubic crystal material or ±400·10³ (J/m³) for a uniaxial anisotropic material. As a result, loss of the high-frequency magnetic material is reduced.

A flattening ratio of 0.36 to 2.50 enables a tan δ to be not higher than 0.1. Since the allowable flattening ratio ranges from 0.36 to 2.50, strict control of a manufacturing process conditions for magnetic particles is not required, so that manufacturing costs of a high-frequency magnetic material can be reduced.

The high-frequency magnetic material can be used in at least one of an antenna, a circuit substrate, and an inductor. For example, use of the high-frequency magnetic material having a low tan δ in the antenna can enhance the radiation efficiency of the antenna.

### Second Embodiment

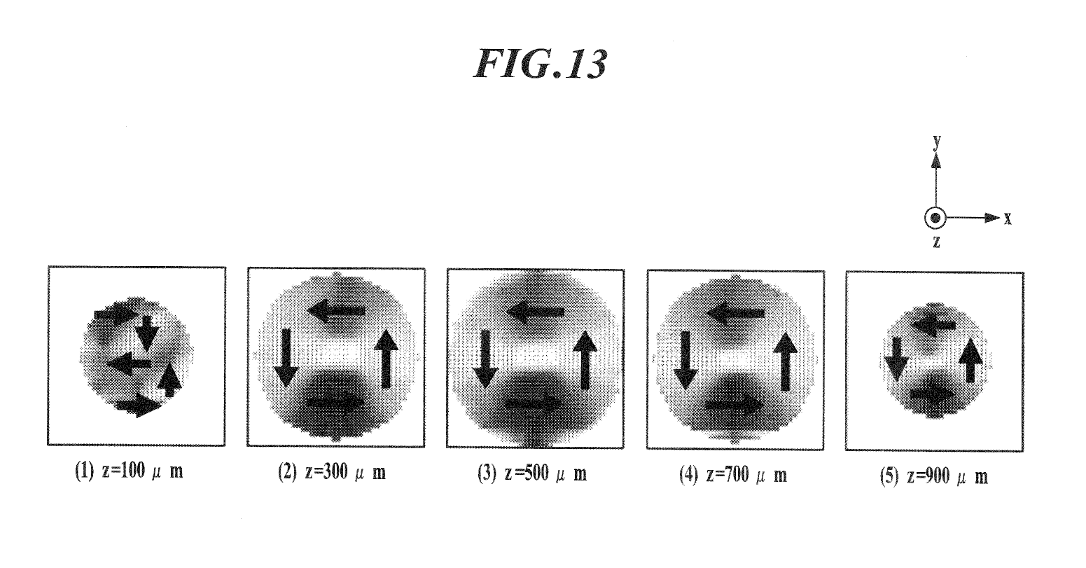

The second embodiment of the present invention will now be described. With reference to FIG. 13, the magnetization distribution inside a magnetic particle calculated by micro-magnetic simulation is described. Specifically, FIG. 13 illustrates a magnetization distribution on the XY plane through simulation of a stabilized magnetization state from a random magnetization distribution state (random magnetization state) of an approximately spherical Fe (iron) magnetic particle with a diameter of 1 μm.

The Z direction is perpendicular to the X and Y directions illustrated in FIG. 1. Specifically, cross sectional views are illustrated at (1) Z=100 μm, (2) 300 μm, (3) 500 μm, (4) 700 μm, and (5) 900 μm, respectively, in FIG. 13. The arrows illustrated in FIG. 13 indicate directions of magnetization.

As illustrated in FIG. 13, the magnetization forms an eddy in the XY plane inmost of the interior of a magnetic particle. Net magnetization is therefore not present in the X and Y directions. The magnetization in the Z direction is present at a central portion of the magnetic particle.

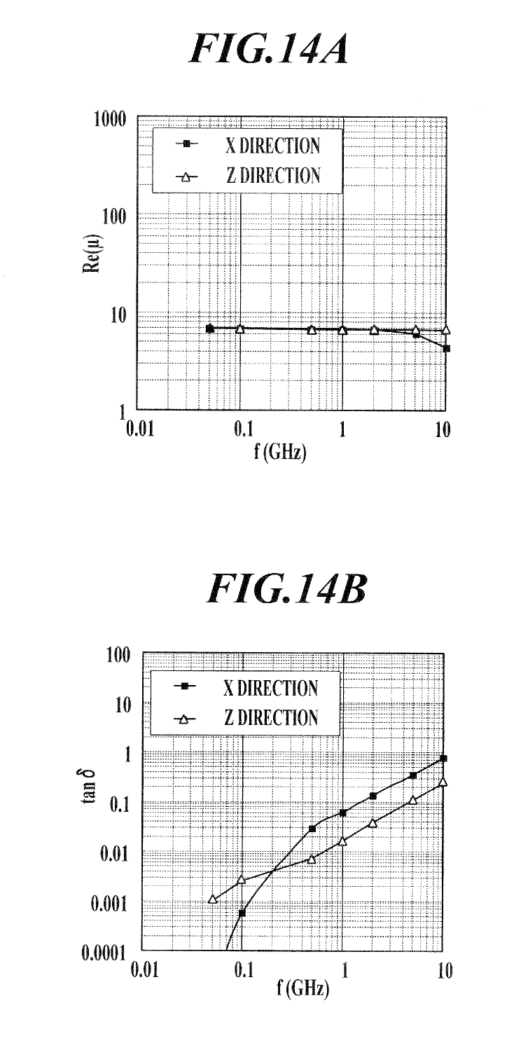

With reference to FIGS. 14A and 14B, characteristics of a magnetic particle (Fe) under an applied magnetic field will now be described. Complex relative magnetic permeability at a high frequency (high-frequency complex relative magnetic permeability) is defined by μ=Re (μ)−j·Im (μ) (where j is imaginary unit), and tan δ=Im (μ)/Re (μ). Commonly used “relative magnetic permeability” means the real part of the complex relative magnetic permeability Re (μ). Hereinafter, the relative magnetic permeability is simply referred to as Re (μ) in this embodiment.

FIG. 14A illustrates magnetic permeability Re (μ) under a magnetic field applied in the X or Z direction. The lateral axis represents frequency. The longitudinal axis represents magnetic permeability Re (μ). FIG. 14B illustrates tan δ under a magnetic field applied in the X or Z direction. The lateral axis represents frequency. The longitudinal axis represents tan δ.

The magnetic permeability Re (μ) was calculated by micro-magnetic simulation. In the micro-magnetic simulation, magnetization response to a high-frequency magnetic field is Fourier-transformed to obtain complex magnetic susceptibility χ=Re (χ)−j·Im (χ) and magnetic permeability Re (μ)=1+Re (χ).

The tan δ was obtained as a magnetic loss component by similar micro-magnetic simulation. An eddy current loss is not included in the result.

As illustrated in FIG. 14A, the magnetic permeability R (μ) is about 7 in each of the X direction and the Y direction. As illustrated in FIG. 14B, the tan δ has different values depending on the direction of the applied magnetic field. Specifically, the tan δ in the Z direction is smaller than that in the X direction. This elucidates that the tan δ is reduced in the magnetization direction. Specifically, since the direction of local magnetization (having only an XY in-plane component, with no Z component) in most of a magnetic particle is perpendicular to the magnetization direction (Z direction), the tan δ in the residual magnetization direction (Z direction) of the magnetic particle is reduced due to a small hysteresis loss and a small domain-wall-resonance loss. The rotational plane of the magnetization eddy and the residual magnetization direction are then switched by magnetization, so that the tan δ in the magnetization direction is reduced.

It has been confirmed that the result illustrated in FIG. 14B was also obtained at least for a particle diameter from 0.1 to 2 μm.

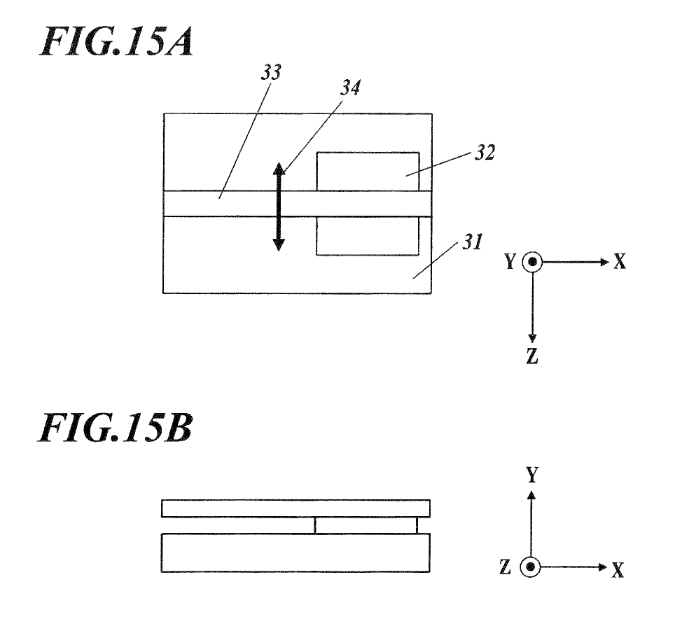

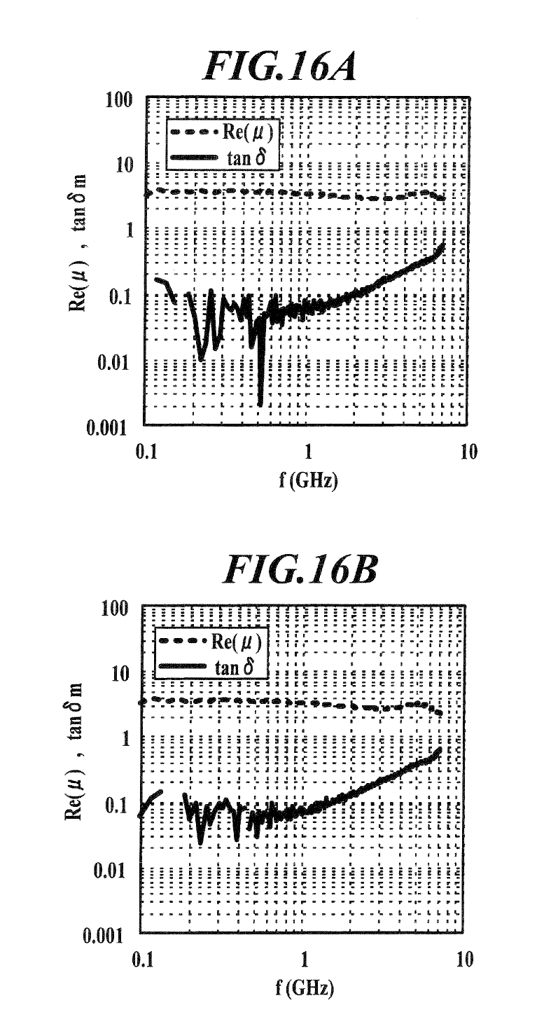

With reference to FIGS. 15A, 15B, 16A, and 16B, the magnetic permeability Re (μ) and tan δ after magnetization of a shaped product (high-frequency magnetic material) made of magnetic particles dispersed in a resin material will now be described. The particles of the shaped product (high-frequency magnetic material) have a particle diameter distribution. The average particle diameter is defined as a median diameter (D50) of a volume-based particle size distribution in this embodiment. The particle size distribution can be evaluated by a static light-scattering process.

The shaped product was made of Fe particles having an average diameter of 1 μm as magnetic particles and PPS (polyphenylene sulfide resin) as a resin, which were heat-kneaded with a kneader at 270° C. for 30 minutes with a volume filling rate of 30 vol %.

This shaped product was machined into sizes of 10 mm by 10 mm by 1 mm thick to evaluate the magnetic permeability Re (μ) and tan δ corresponding to the magnetization direction with a magnetic material characteristics measurement system made by Keycom Corp. In the evaluation, the sample was magnetized in a magnetic field parallel to the direction of a measurement magnetic field (parallel magnetization, for example, magnetization direction in the Z direction) and in a magnetic field perpendicular to the direction of a measurement magnetic field (vertical magnetization, for example, magnetization direction in the X direction or the Y direction). The sample (shaped product) was inserted in a gap between opposing permanent magnets, so as to be magnetized under a magnetic field of 5 kOe.

FIGS. 15A and 15B illustrate a relation between the direction of the measurement magnetic field (measurement system) and coordinate axes (X, Y, and Z axes). A ground 31, a sample 32 (high-frequency magnetic material), and a signal line 33 are illustrated in FIGS. 15A and 15B. An arrow 34 of the measurement magnetic field is illustrated. FIG. 15A is a top view of the measurement system. FIG. 15B is a side view of the measurement system. The X, Y, and Z axes correspond to the coordinate axes of FIG. 15B. The arrow 34 therefore indicates a measurement magnetic field in the Z direction.

FIG. 16A illustrates the evaluated results of the magnetic permeability Re (μ) and tan δ after parallel magnetization. FIG. 16B illustrates the evaluated results of the magnetic permeability Re (μ) and tan δ after vertical magnetization. Among the evaluated results, the magnetic permeability Re (μ) has approximately identical results regardless of the magnetization direction.

In contrast, the tan δ had different values depending on the magnetization direction. Specifically, the tan δ at 1.5 GHz was 0.071 (^{+0.004}, _{-0.002}) for the parallel magnetization and 0.10 (^{+0.008}, _{-0.004}) for the vertical magnetization in five measurements. The results confirm that the parallel magnetization has a lower tan δ compared to the vertical magnetization.

It is believed that an unmagnetized isotropic sample (high-frequency magnetic material having an isotropic magnetic permeability Re (μ) and tan δ in the three axes) has characteristics averaged among the X, Y, and Z directions. Since the tan δ was 0.10 in the X direction, 0.10 in the Y direction, and 0.071 in the Z direction in this case, the tan δ in the isotropic specimen is represented by:

tan δ=(0.10+0.10+0.071)/3=0.09

A parallel-magnetized high-frequency magnetic material therefore has a lower tan δ compared to an unmagnetized isotropic high-frequency magnetic material.

The magnetization direction is determined based on the direction of a principal magnetic-field action (direction in which a low tan δ is required) of an actual product of a high-frequency magnetic material (high-frequency device) during the operation of the product. For example, in the case where the actual product is an antenna, magnetization is performed in the direction of the principal magnetic-field action during the operation of the antenna.

In FIGS. 15A, 15B, 16A, and 16B, the magnetic particles were magnetized after being dispersed in a resin material. Alternatively, the magnetic particles may be magnetized during dispersion in a resin material (during manufacturing a shaped product).

The high-frequency magnetic material of this embodiment can be applied to a high-frequency device (an antenna, an inductor, or a circuit substrate) illustrated in FIGS. 9A to 12, as in the first embodiment.

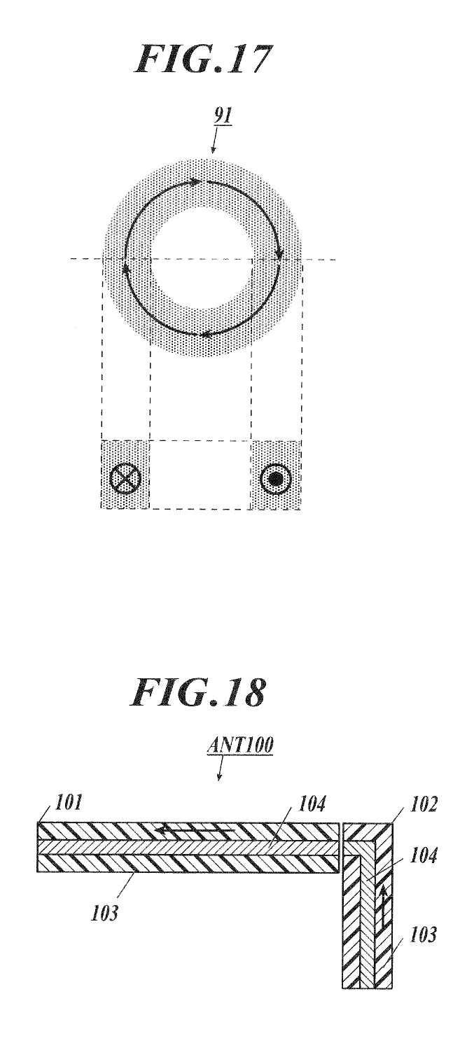

The magnetization direction may be nonlinear rather than linear. For example, a toroidal coil 91 of the high-frequency magnetic material as illustrated in FIG. 17 may be magnetized in a circumferential direction.

A plurality of individually magnetized members may be integrated. For example, a member 101 and a member 102 may be individually magnetized along the respective arrows as illustrated in FIG. 18 and then be integrated into an antenna 100. The members 101 and 102 each comprise a high-frequency magnetic material 103 and an electrode 104. The antenna 100 can be manufactured by integrating the member 101 and the member 102. The electrode 104 may be formed over each of the high-frequency magnetic materials 101 and 102 or may extend through each of the high-frequency magnetic materials 101 and 102.

This embodiment can reduce tan δ through magnetization of a high-frequency magnetic material composed of approximately spherical magnetic particles dispersed in a resin material. A reduction in loss of a high-frequency magnetic material can be thereby achieved.

Magnetic particles can be magnetized during or after the dispersion of the particles in a resin material.

The high-frequency magnetic material can be applied to at least one of an antenna, a circuit substrate, and an inductor. For example, use of the high-frequency magnetic material having a low tan δ in an antenna can enhance the radiation efficiency of the antenna.

The description of the foregoing embodiments is mere examples of the high-frequency magnetic material and high-frequency device of the present invention, which is not limited thereto.

For example, the surfaces of magnetic particles may be coated with a nonmagnetic material (e.g., phosphate salt or silica), so that a high-frequency magnetic material may be formed of the coated magnetic particles.

The high-frequency magnetic material is not limited to a composite material of a magnetic material and a resin as in the embodiment. For example, the high-frequency magnetic material may be composed of a composite material of a magnetic material and an inorganic material (inorganic dielectrics, glass filler, or conductive material).

The usable resin may be selected from various thermosetting or thermoplastic resins.

The kneading device may be an extruder, a kneader, or a bead mill.

The shaping process may be injection molding, extrusion molding, or compaction molding.

### INDUSTRIAL APPLICABILITY

The present invention is applicable to a high-frequency magnetic material including magnetic particles dispersed in a resin material, and applicable to a high-frequency device to which the high-frequency magnetic material is applied.

### REFERENCE NUMERALS

1A, 1B, 1C, 1D, 1E, 1F high-frequency magnetic material
2A, 2D, 2E ground plate
3A, 3B, 3C, 3D, 3E electrode

1. A high-frequency magnetic material comprising:
magnetic particles dispersed in a resin material;
wherein:
the magnetic particles have an approximately spherical shape;
the resin material contains 1 to 60 vol % of the magnetic particles;
the magnetic particles have a saturated flux density of 1 T or more; and
a magnetic anisotropy constant of the magnetic particles is K1<±800·10³ (J/m³ ) for a cubic crystal material or Ku<±400·10³ (J/m³) for a uniaxial anisotropic material.

2. A high-frequency magnetic material comprising:
magnetic particles dispersed in a resin material;
wherein the magnetic particles have an approximately spherical shape with an average diameter d of 0.1 μm<d<1 μm and a relative particle volume f(d) at each diameter satisfying a relationship:
Σ{f(d)·d²}<6.7·10⁻¹².

3. The high-frequency magnetic material according to claim 1, wherein the magnetic particles have a flattening ratio in a range of 0.36 to 2.50.

4. A high-frequency magnetic material comprising:
magnetic particles dispersed in a resin material,
wherein the magnetic particles have an approximately spherical shape and the magnetic material is magnetized.

5. The high-frequency magnetic material according to claim 4, wherein the magnetic particles have an eddy magnetization distribution therewithin.

6. The high-frequency magnetic material according to claim 4, wherein the magnetic material is magnetized while the magnetic particles are being dispersed in the resin material or after the magnetic particles are dispersed in the resin material.

7. The high-frequency magnetic material according to claim 4, wherein the magnetic material is magnetized in a direction parallel to a principal magnetic-field-action direction of an applied device.

8. A high-frequency device comprising at least one of an antenna, a circuit substrate, and an inductor composed of the high-frequency magnetic material according to claim 1.

9. The high-frequency magnetic material according to claim 2, wherein the magnetic particles have a flattening ratio in a range of 0.36 to 2.50.

10. The high-frequency magnetic material according to claim 5, wherein the magnetic material is magnetized while the magnetic particles are being dispersed in the resin material or after the magnetic particles are dispersed in the resin material.

11. The high-frequency magnetic material according to claim 5, wherein the magnetic material is magnetized in a direction parallel to a principal magnetic-field-action direction of an applied device.

12. The high-frequency magnetic material according to claim 6, wherein the magnetic material is magnetized in a direction parallel to a principal magnetic-field-action direction of an applied device.

13. A high-frequency device comprising at least one of an antenna, a circuit substrate, and an inductor composed of the high-frequency magnetic material according to claim 2.

14. A high-frequency device comprising at least one of an antenna, a circuit substrate, and an inductor composed of the high-frequency magnetic material according to claim 4.
